(19) United States
(12) Patent Application Publication
(10) Pub. No.: US 2026/0011506 A1
(43) Pub. Date: Jan. 8, 2026

(54) LAMINATED CERAMIC CAPACITOR AND METHOD OF MANUFACTURING LAMINATED CERAMIC CAPACITOR

(71) Applicant: TAIYO YUDEN CO., LTD., Tokyo (JP)

(72) Inventor: Katsuya TANIGUCHI, Tokyo (JP)

(21) Appl. No.: 19/329,264

(22) Filed: Sep. 15, 2025

Related U.S. Application Data
(63) Continuation of application No. PCT/JP2024/003784, filed on Feb. 5, 2024.

(30) Foreign Application Priority Data
Mar. 16, 2023 (JP) 2023-042426

(51) Int. Cl. H01G 4/30; H01G 4/12

(52) U.S. Cl. CPC H01G 4/30; H01G 4/1209

(57) ABSTRACT

An aspect pf the present invention provides a laminated ceramic capacitor including a body, a first external electrode, and a second external electrode. The body includes a first internal electrode layer, a second internal electrode layer and a dielectric layer. The body is at least partitioned into a capacitance region and a margin region. The capacitance region is the region where the first internal electrode layer and the second internal electrode layer face each other in a first direction. The margin region is the region where neither the first internal electrode layer nor the second internal electrode layer is present as viewed from the first direction. In one aspect, the dielectric layer contains Fe in a first concentration in the capacitance region and contains Fe in a second concentration higher than the first concentration in the margin region.

### CROSS-REFERENCE TO RELATED APPLICATIONS

This is a continuation application of a PCT application No. PCT/JP2024/3784 filed on Feb. 5, 2024, which is based on and claims the benefit of priority from Japanese patent Application serial No. 2023-042426 (filed on Mar. 16, 2023). The contents of the PCT and Japanese applications are hereby incorporated by reference in their entirety.

### TECHNICAL FIELD

The disclosure herein relates mainly to a laminated ceramic capacitor and a method of manufacturing the laminated ceramic capacitor. The disclosure herein also relates to a circuit module with the laminated ceramic capacitor and an electronic device with the circuit module.

### BACKGROUND

Laminated ceramic capacitors are installed in various electronic device. Laminated ceramic capacitors have dielectric layers and internal electrode layers that are stacked on each other. Upon application of voltage to the internal electrode layers of the laminated ceramic capacitors, capacitance is generated in a capacitance generating region where the dielectric layers and the internal electrode layers face each other in the lamination direction. The laminated ceramic capacitors may easily allow moisture in the external atmosphere to penetrate into the interior through the outer edges of the dielectric layers, which surround the capacitance generating region. In order to ensure moisture resistance, it is thus necessary to improve the sinterability of the outer edges of the dielectric layers. Densification of the outer edges of the dielectric layers can prevent the moisture in the external atmosphere from entering the interior of the laminated ceramic capacitors.

Densification of the dielectric layers can be effectively accomplished by adding a sintering agent to the raw materials of the dielectric layers. For example, Japanese Patent Application Publication Nos. 2010-103566 and 2022-020803 disclose a laminated ceramic capacitor with a dielectric layer that is densified by firing a precursor to which a sintering agent is added. These prior art documents introduce, as the sintering agent, Mn (manganese), Mg (magnesium), Si (silicon), B (boron), Ho (holmium), Ca (calcium), V (vanadium) and their oxides, as well as glass principally composed of Si (silicon) containing Li (lithium), K (potassium), Na (sodium) and B (boron).

Laminated ceramic capacitors are made by firing laminates each consisting of a dielectric green sheet and an internal electrode pattern stacked on each other, which are respectively the precursors of the dielectric layer and the internal electrode layer. During firing of the laminates, Ni contained in the internal electrode pattern as the main component metal of the internal electrode layer diffuses into the dielectric green sheet, and the diffused Ni promotes densification of the dielectric layer. While Ni diffuses mostly into the capacitance region in the dielectric layer, it is less likely to diffuse into the margin region, where the internal electrode pattern is not formed as viewed from the lamination direction.

Since Ni diffuses non-uniformly into the dielectric green sheet during firing of the laminate, the firing proceeds readily in the capacitance region in the dielectric layer but is less facilitated in the margin region. The firing may be performed at high temperatures to promote densification of the dielectric layer in the margin region, but the firing will excessively occur in the capacitance region. The excessive firing of the dielectric layer in the capacitance region can lead to a decrease in the insulation reliability of the laminate ceramic capacitor.

### SUMMARY

It is an object of the present disclosure to solve or alleviate at least part of the drawback mentioned above. One of the more particular objects of the disclosure is to facilitate the densification of the dielectric layer in the margin region of the laminated ceramic capacitor without impairing the insulation reliability.

Other objects of the disclosure will be made apparent through the entire description in the specification. The invention disclosed herein may also address drawbacks other than that grasped from the above description. When an advantageous effect of an embodiment is described herein, the advantageous effect suggests an object of the invention corresponding to the embodiment.

The various inventions disclosed herein may be collectively referred to as “the invention”. An aspect of the present invention provides a laminated ceramic capacitor including a body, a first external electrode, and a second external electrode. In one aspect, the body includes a first internal electrode layer, a second internal electrode layer and a dielectric layer. In one aspect, the dielectric layer is disposed between the first internal electrode layer and the second internal electrode layer in a first direction. The first external electrode is provided on the body so as to be electrically connected to the first internal electrode layer. The second external electrode provided on the body so as to be electrically connected to the second internal electrode layer. In one aspect, the body is at least partitioned into a capacitance region and a margin region. In one aspect, the capacitance region is the region where the first internal electrode layer and the second internal electrode layer face each other in the first direction. In one aspect, the margin region is the region where neither the first internal electrode layer nor the second internal electrode layer are present as viewed from the first direction. In one aspect, the dielectric layer contains Fe in a first concentration in the capacitance region and contains Fe in a second concentration higher than the first concentration in the margin region.

### Advantageous Effects

One embodiment of the disclosure herein can facilitate the densification of the dielectric layer in the margin region of the laminated ceramic capacitor without impairing the insulation reliability.

### BRIEF DESCRIPTION OF THE DRAWINGS

FIG. 1 is a perspective view schematically showing a laminated ceramic capacitor according to one embodiment of the disclosure.

FIG. 2 is a sectional view schematically showing a section of the laminated ceramic capacitor of FIG. 1 along the line I-I.

FIG. 3 is a sectional view schematically showing a section of the laminated ceramic capacitor of FIG. 1 along the line II-II.

FIG. 4 is a plan view showing the laminated ceramic capacitor of FIG. 1.

FIG. 5 is a flowchart showing a manufacturing method of a laminated ceramic capacitor according to one embodiment of the disclosure.

FIG. 6 is a flowchart showing a flow of steps for manufacturing a laminate.

FIG. 7A schematically illustrates part of the steps for manufacturing a lamination unit.

FIG. 7B schematically illustrates part of the steps for manufacturing a lamination unit.

FIG. 7C schematically illustrates part of the steps for manufacturing a lamination unit.

FIG. 8A schematically illustrates part of the steps for manufacturing a lamination unit.

FIG. 8B schematically illustrates part of the steps for manufacturing a lamination unit.

FIG. 8C schematically illustrates part of the steps for manufacturing a lamination unit.

FIG. 9A schematically illustrates part of the steps for manufacturing a lamination unit.

FIG. 9B schematically illustrates part of the steps for manufacturing a lamination unit.

FIG. 9C schematically illustrates part of the steps for manufacturing a lamination unit.

FIG. 10A schematically illustrates part of the steps for manufacturing a lamination unit.

FIG. 10B schematically illustrates part of the steps for manufacturing a lamination unit.

FIG. 10C schematically illustrates part of the steps for manufacturing a lamination unit.

FIG. 11 is a sectional view schematically showing a chip laminate.

FIG. 12 schematically shows a modification example of a lamination unit U1.

FIG. 13 schematically shows a modification example of a lamination unit U2.

FIG. 14A schematically illustrates part of the steps for manufacturing a lamination unit U201.

FIG. 14B schematically illustrates part of the steps for manufacturing the lamination unit U201.

FIG. 14C schematically illustrates part of the steps for manufacturing the lamination unit U201.

FIG. 15A schematically illustrates part of the steps for manufacturing the lamination unit U202.

FIG. 15B schematically illustrates part of the steps for manufacturing the lamination unit U202.

FIG. 15C schematically illustrates part of the steps for manufacturing a lamination unit U202.

FIG. 16A is a sectional view schematically showing a laminate formed by stacking the lamination units U201 and U202.

FIG. 16B is a sectional view schematically showing a chip laminate.

### DESCRIPTION OF THE PREFERRED EMBODIMENTS

Various embodiments of the disclosure will be described hereinafter with reference to the appended drawings. Throughout the drawings, the same components are denoted by the same or like reference numerals. For convenience of explanation, the drawings are not necessarily drawn to scale. The following embodiments of the disclosure do not limit the scope of the claims. The elements included in the following embodiments are not necessarily essential to solve the problem addressed by the invention.

For convenience of explanation, each of the drawings may show the L axis, the W axis, and the T axis orthogonal to one another. In this specification, the dimensions, arrangement, shape, and other features of each component of a laminated ceramic capacitor 1 may be described with reference to the L, W, and T axes.

### (1) Laminated Ceramic Capacitor 1

### (1-1) Basic Structure of Laminated Ceramic Capacitor 1

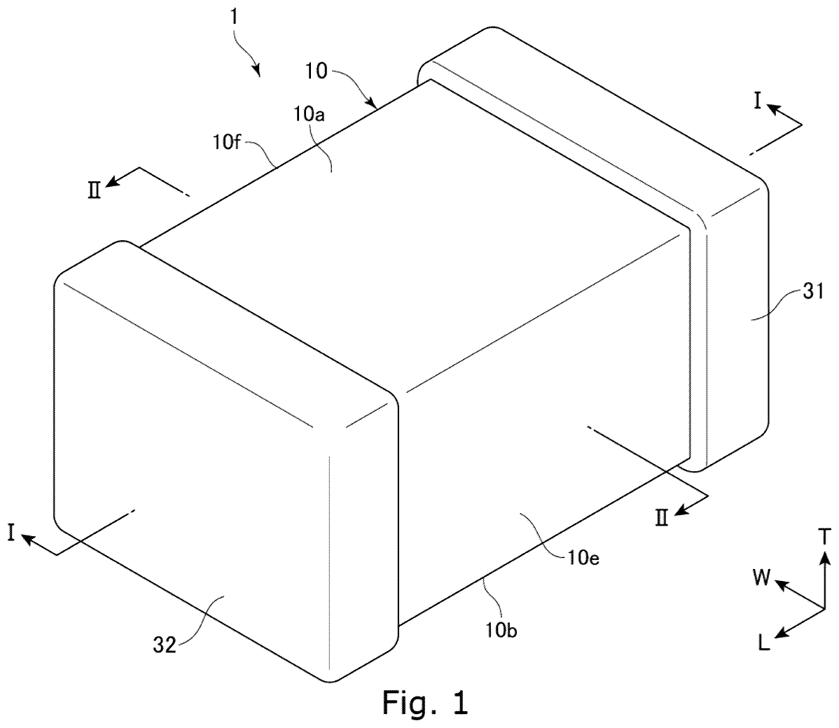

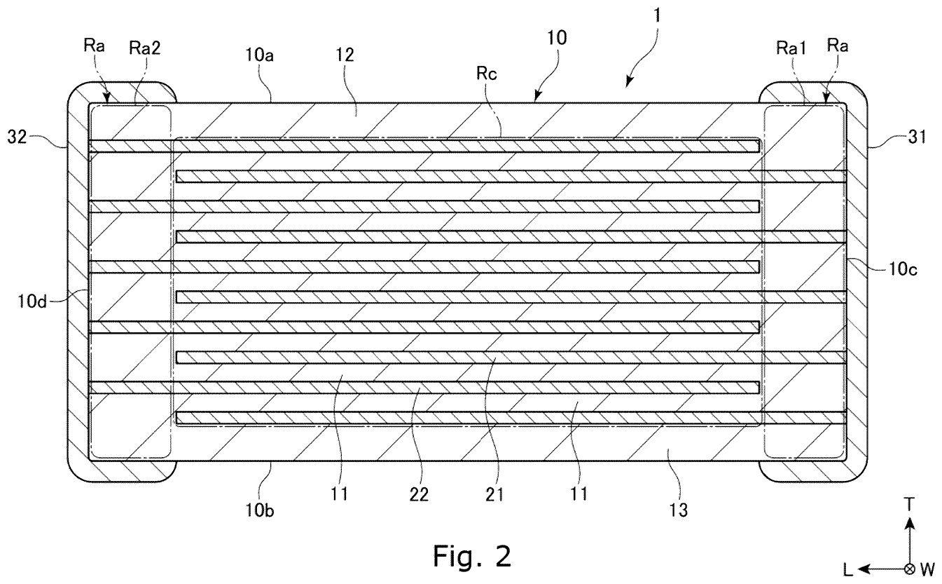

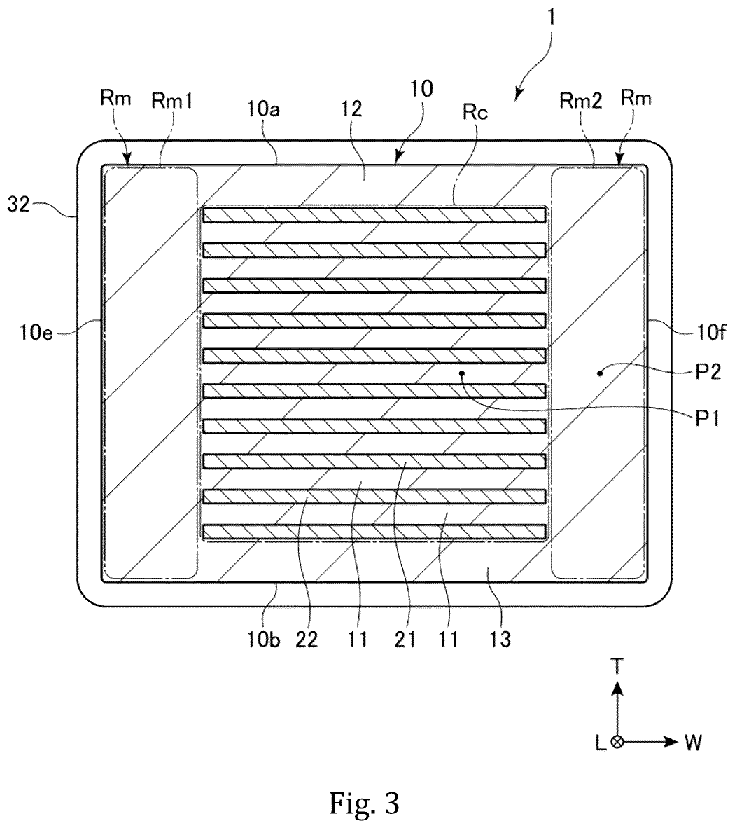

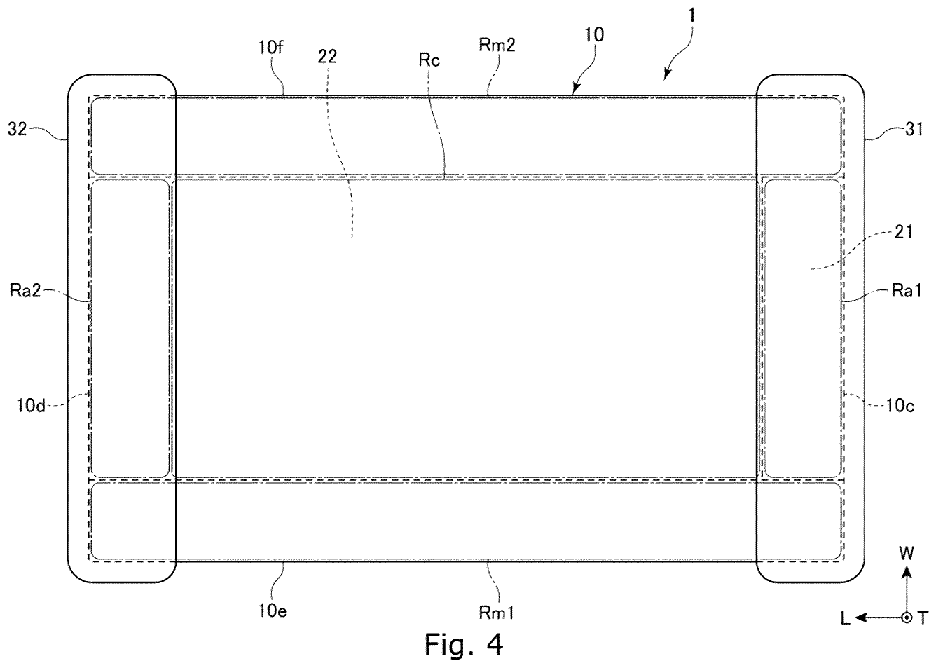

Referring to FIGS. 1 to 4, a description will now be given of the basic structure of a laminated ceramic capacitor 1 according to one embodiment. FIG. 1 is a perspective view showing the laminated ceramic capacitor 1 according to the embodiment. FIG. 2 is a sectional view schematically showing a section of the laminated ceramic capacitor 1 along the line I-I. FIG. 3 is a sectional view schematically showing a section of the laminated ceramic capacitor 1 along the line II-II. FIG. 4 is a plan view showing the laminated ceramic capacitor 1.

The laminated ceramic capacitor 1 has a body 10, and a first external electrode 31 and a second external electrode 32 provided on the body 10. In the example shown in FIG. 2, the first external electrode 31 is spaced apart from the second external electrode 32.

The body 10 includes a plurality of dielectric layers 11, a plurality of first internal electrode layers 21, and a plurality of second internal electrode layers 22. In this specification, the first internal electrode layers 21 and the second internal electrode layers 22 may be referred to collectively as “the internal electrode layers” when it is not necessary to distinguish the first internal electrode layers 21 and the second internal electrode layers 22 from each other. In the body 10, each dielectric layer 11 is positioned between adjacent ones of the internal electrode layers. For example, in the body 10, a first internal electrode layer 21 is provided on the top surface of a dielectric layer 11, and a second internal electrode layer 22 is provided on the bottom surface of the dielectric layer 11.

The body 10 is composed of the dielectric layers 11, the first internal electrode layers 21, and the second internal electrode layers 22 stacked together along the lamination direction. In the illustrated embodiment, the dielectric layers 11, the first internal electrode layers 21, and the second internal electrode layers 22 are stacked together along the T-axis direction. The lamination direction may be along the T axis, as in the illustrated embodiment, or may be along the L or W axis.

The dielectric layers 11 located at the opposite ends in the lamination direction may be referred to as cover layers. In the example shown in FIG. 2, an upper cover layer 12 is provided at the top end in the lamination direction, and a lower cover layer 13 is provided at the bottom end in the lamination direction. The upper cover layer 12 and the lower cover layer 13 may be formed of the same material as the dielectric layers 11. The upper cover layer 12 and the lower cover layer 13 may be a part of the body 10.

The body 10 has a top surface 10a, a bottom surface 10b, a first end surface 10c, a second end surface 10d, a first side surface 10e, and a second side surface 10f. The outer surface of the body 10 is defined by the top surface 10a, the bottom surface 10b, the first end surface 10c, the second end surface 10d, the first side surface 10e, and the second side surface 10f.

The top surface 10a and the bottom surface 10b form the opposite ends of the body 10 in the height direction (T-axis direction). In other words, the top surface 10a and the bottom surface 10b are opposed to each other in the T-axis direction. The first end surface 10c and the second end surface 10d form the opposite ends of the body 10 in the length direction (L-axis direction). In other words, the first end surface 10c and the second end surface 10d are opposed to each other in the L-axis direction. The first side surface 10e and the second side surface 10f form the opposite ends of the body 10 in the width direction (W-axis direction). In other words, the first side surface 10e and the second side surface 10f are opposed to each other in the W-axis direction. The top surface 10a and the bottom surface 10b are separated from each other by a distance equal to the height of the body 10, the first end surface 10c and the second end surface 10d are separated from each other by a distance equal to the length of the body 10, and the first side surface 10e and the second side surface 10f are separated from each other by a distance equal to the width of the body 10.

Each of the first internal electrode layers 21 has one end led toward the outside of the body 10. The first internal electrode layer 21 is connected to the first external electrode 31 provided on the surface of the body 10. Each of the second internal electrode layers 22 has one end led toward the outside of the body 10. The second internal electrode layer 22 is connected to the second external electrode 32 provided on the surface of the body 10. In the embodiment shown in FIG. 2, the first internal electrode layer 21 is led through the first end surface 10c toward the outside of the body 10. The first internal electrode layer 21 is connected to the first external electrode 31 at one end of the body 10 in the L-axis direction. The second internal electrode layer 22 is led through the second end surface 10d toward the outside of the body 10. The second internal electrode layer 22 is connected to the second external electrode 32 at the other end of the body 10 in the L-axis direction. In the example shown in FIG. 2, the first and second internal electrode layers 21 and 22 are respectively led out to the first and second end surfaces 10c and 10d, which are opposed to each other, but the first and second internal electrode layers 21 and 22 can be led out through various surfaces of the body 10 in accordance with the locations and the shapes of the first and second external electrodes 31 and 32. For example, if both the first and second external electrodes 31 and 32 are located on the bottom surface 10b, both the first and second internal electrode layers 21 and 22 are led out through the bottom surface. The first and second external electrodes 31 and 32 may be located on any of the surfaces of the body 10 as long as they are separated from each other.

In one aspect, the laminated ceramic capacitor 1 may be configured to have a rectangular parallelepiped shape. The term “rectangular parallelepiped” or “rectangular parallelepiped shape” used herein is not intended to mean solely “rectangular parallelepiped” in a mathematically strict sense. As described below, the corners and/or edges of the body 10 may be rounded. The dimensions and the shape of the body 10 are not limited to those specified herein.

In one aspect, the laminated ceramic capacitor 1 has a dimension in the L-axis direction (length) of 0.2 mm to 2.5 mm, a dimension in the W-axis direction (width) of 0.1 mm to 3.5 mm, and a dimension in the T-axis direction (height) of 0.1 mm to 3.0 mm. In one aspect, the length of the laminated ceramic capacitor 1 may be larger than the width thereof. In one aspect, the height of the laminated ceramic capacitor 1 may be larger than the width thereof. In one aspect, the width of the laminated ceramic capacitor 1 may be larger than the length thereof.

The laminated ceramic capacitor 1 may be mounted on an electronic circuit board. The electronic circuit board having the laminated ceramic capacitor 1 mounted thereon may be referred to as a circuit module. Various electronic components other than the laminated ceramic capacitor 1 may also be mounted on the circuit module. The circuit module may be installed in various electronic devices.

The electronic devices in which the circuit module can be installed include smartphones, tablets, game consoles, electrical components of automobiles, servers, and various other electronic devices.

### (1-2) Regions of Body 10

The body 10 may be partitioned into a plurality of regions. In the illustrated embodiment, the body 10 is partitioned at least into a capacitance region Rc, a first lead-out region Ra1, a second lead-out region Ra2, a first margin region Rm1, and a second margin region Rm2.

In the capacitance region Rc, the first and second internal electrode layers 21 and 22 are opposed to each other with the dielectric layers 11 being therebetween, as viewed in the lamination direction. When voltage is applied between the first and second external electrodes 31 and 32, capacitance is generated between the first and second internal electrode layers 21 and 22. In other words, the capacitance region Rc is the region where the first and second internal electrode layers 21 and 22 face each other in the lamination direction and where capacitance is generated.

As shown in FIGS. 2 and 4, the first lead-out region Ra1 is the region between the capacitance region Rc and the surface of the body 10 through which the first internal electrode layers 21 are led out. Since the first internal electrode layers 21 are led out through the first end surface 10c in the illustrated embodiment, the first lead-out region Ra1 is between the capacitance region Rc and the first end surface 10c. As shown in FIG. 4, the first lead-out region Ra1 is the region where the first internal electrode layers 21 are present but the second internal electrode layers 22 are absent when viewed from the lamination direction. In the first lead-out region Ra1, adjacent ones of the first internal electrode layers 21 are opposed to each other with the dielectric layers 11 being therebetween as viewed in the lamination direction. The second lead-out region Ra2 is the region between the capacitance region Rc and the surface of the body 10 through which the second internal electrode layers 22 are led out. Since the second internal electrode layers 22 are led out through the second end surface 10d in the illustrated embodiment, the second lead-out region Ra2 is between the capacitance region Rc and the second end surface 10d. As shown in FIG. 4, the second lead-out region Ra2 is the region where the second internal electrode layers 22 are present but the first internal electrode layers 21 are absent when viewed from the lamination direction. In the second lead-out region Ra2, adjacent ones of the second internal electrode layers 22 are opposed to each other with the dielectric layers 11 being therebetween as viewed in the lamination direction. In this specification, the first and second lead-out regions Ra1 and Ra2 may be referred to collectively as “lead-out regions Ra” when it is not necessary to distinguish the first and second lead-out regions Ra1 and Ra2.

As shown in FIGS. 3 and 4, the first margin region Rm1 is the region where neither the first internal electrode layers 21 nor the second internal electrode layers 22 are present when viewed from the lamination direction. In the illustrated embodiment, the first margin region Rm1 is between the capacitance region Rc and the first side surface 10e and between the lead-out regions Ra and the first side surface 10e. Like the first margin region Rm1, the second margin region Rm2 is also the region where neither the first internal electrode layers 21 nor the second internal electrode layers 22 are present when viewed from the lamination direction. In the illustrated embodiment, the second margin region Rm2 is between the capacitance region Rc and the second side surface 10f and between the lead-out regions Ra and the second side surface 10f. In this specification, the first and second margin regions Rm1 and Rm2 may be referred to collectively as “margin regions Rm” when it is not necessary to distinguish the first and second margin regions Rm1 and Rm2. In the illustrated embodiment, the margin regions Rm are located between the capacitance region Rc and the first side surface 10e and between the capacitance region Rc and the second side surface 10f when viewed from the lamination direction. However, the margin regions Rm may be located in various regions around the capacitance region Rc depending on the lamination direction and the positions of the first and second external electrodes 31 and 32. For example, when the first and second internal electrode layers 21 and 22 are stacked in the L-axis direction and lead out through the bottom surface 10b, the margin regions Rm are the regions between the capacitance region Rc and the top surface 10a, between the capacitance region Rc and the first side surface 10e, and between the capacitance region Rc and the second side surface 10f. In this case, the margin regions Rm can also include a part of the region between the capacitance region Rc and the bottom surface 10b (the region where neither the first internal electrode layers 21 nor the second internal electrode layers 22 are present as viewed from the L-axis direction or the lamination direction). As another example, when the first and second internal electrode layers 21 and 22 are stacked in the W-axis direction and lead out through the bottom surface 10b, the margin regions Rm are the regions between the capacitance region Rc and the top surface 10a, between the capacitance region Rc and the first end surface 10c, and between the capacitance region Rc and the second end surface 10d. In this case, the margin regions Rm can also include a part of the region between the capacitance region Rc and the bottom surface 10b (the region where neither the first internal electrode layers 21 nor the second internal electrode layers 22 are present as viewed from the W-axis direction or the lamination direction).

### (1-3) Dielectric Layer 11

The dielectric layers 11 contain as their main component an oxide represented by a chemical formula ABO₃. The oxide may have a perovskite structure. A component that is at least 50 wt % of the dielectric layers 11 with reference to the total mass of the dielectric layers 11 can be regarded as the main component of the dielectric layers 11. When the dielectric layers 11 contain 50 wt % or more of the oxide represented by the chemical formula ABO₃, the dielectric layers 11 can be considered to contain the oxide represented by the chemical formula ABO₃ as their main component. The dielectric layers 11 preferably contain at least 60 wt %, 70 wt %, 80 wt %, or 90 wt % of the oxide represented by the chemical formula ABO₃.

In the chemical formula ABO₃, “A” is at least one element selected from the group consisting of Ba (barium), Sr (strontium), Ca (calcium), and Mg (magnesium). In the chemical formula ABO₃, “B” is at least one element selected from the group consisting of Ti (titanium), Zr (zirconium), and Hf (hafnium). When the oxide represented by the chemical formula ABO₃ has a perovskite structure, the elements “A” and “B” are located at the A site and the B site of the perovskite structure, respectively. Examples of the oxide contained in the dielectric layers 11 as their main component include BaTiO₃ (barium titanate), CaZrO₃ (calcium zirconate), CaTiO₃ (calcium titanate), SrTiO₃ (strontium titanate), and MgTiO₃ (magnesium titanate).

The oxide contained in the dielectric layers 11 as the main component may be an oxide represented by the chemical formula Ba_{1-x-y}CaₓSr_{y}Ti_{1-z}Zr_{z}O₃ (0≤x≤1, 0≤y≤1, 0≤z≤1). Examples of this type of oxide include strontium barium titanate, calcium barium titanate, barium zirconate, barium zirconate titanate, calcium zirconate titanate, and calcium barium zirconate titanate.

The dielectric layers 11 contain Fe (iron) in addition to the oxide or the main component. The Fe concentration in the dielectric layers 11 will be described below.

The dielectric layers 11 may contain elements that can originate from known sintering agents, in addition to the oxide or the main component. Examples of the known sintering agents are Mg (magnesium) and Mn (manganese).

The dielectric layers 11 may include additive elements. In one aspect, the additive elements contained in the dielectric layers 11 are at least one element selected from the group consisting of Ni (nickel), Mo (molybdenum), Nb (niobium), Ta (tantalum), W (tungsten), V (vanadium), and Cr (chromium). The dielectric layers 11 may contain two or more of the above additive elements.

The dielectric layers 11 may contain oxides of rare earth elements in addition to the oxide or the main component. The oxides of rare earth elements contained in the dielectric layers 11 may be oxides of at least one rare earth element selected from the group consisting of Y (yttrium), Sm (samarium), Eu (europium), Gd (gadolinium), Tb (terbium), Dy (dysprosium), Ho (holmium), Er (erbium), Tm (thulium), and Yb (ytterbium). The dielectric layers 11 may contain oxides of two or more rare earth elements.

The dielectric layers 11 may contain yet another type of oxide. The dielectric layers 11 may contain oxides of at least one element selected from the group consisting of, for example, Co (cobalt), Li (lithium), B (boron), Na (sodium), K (potassium), and Si (silicon). The dielectric layers 11 may contain oxides of two or more of these elements.

The dielectric layers 11 may contain glass containing at least one element selected from the group consisting of Co, Ni, Li, B, Na, K, and Si.

In one aspect, the thickness (the dimension in the T-axis direction) of each dielectric layer 11 is 0.2 to 5 μm. The lower limit for the thickness of the dielectric layer 11 may be 1.5 μm. The upper limit for the thickness of the dielectric layer 11 may be 3 μm.

### (1-4) First Internal Electrode Layers 21 and Second Internal Electrode Layers 22

In one aspect, the first internal electrode layers 21 contain a base metal such as Ni (nickel), Cu (copper), and Sn (tin), as the main component thereof. A component that is at least 50 wt % of the first internal electrode layers 21 with reference to the total mass of the first internal electrode layers 21 can be regarded as the main component of the first internal electrode layers 21. The first internal electrode layers 21 preferably contain 60 wt % or more, 70 wt % or more, 80 wt % or more, or 90 wt % or more of the base metal as the main component thereof.

The first internal electrode layers 21 can contain additive metal elements in addition to the main component metal element. The additive metal elements that can be contained in the first internal electrode layers 21 are, for example, metals that are more noble than the main component metal of the first internal electrode layers 21. The additive metal elements that can be contained in the first internal electrode layers 21 are one or more elements selected from the group consisting of, for example, Au, Sn, Cr, Y, In (indium), As (arsenic), Co, Cu, Ir (iridium), Mg, Os (osmium), Pd, Pt, Re (rhenium), Rh (rhodium), Ru (ruthenium), Se (selenium), Te (tellurium), W and Zn (zinc).

The description of the components of the first internal electrode layers 21 also applies to the components of the second internal electrode layers 22.

### (1-5) First External Electrode 31 and Second External Electrode 32

In one aspect, the first and second external electrodes 31 and 32 are formed by applying a conductive paste to the body 10 and heating the conductive paste. The conductive paste can contain at least one substance from the group consisting of Ag (silver), Pd (palladium), Au (gold), Pt (platinum), Ni (nickel), Sn (tin), Cu (copper), W (tungsten), Ti (titanium), and alloys of these.

### (1-6) Fe Concentration

As described above, the dielectric layers 11 contain Fe. Noting that Fe promotes sintering of dielectric materials, the inventors of the present invention have demonstrated that, by controlling the Fe concentration of the dielectric layers 11 so as to be higher in the margin regions Rm (a second concentration) than in the capacitance region Rc, the margin regions Rm of the dielectric layers 11 can be densified to a greater extent without increasing the firing temperature compared to the case where Fe is not added to the dielectric layers 11.

In one aspect of the present invention, the second concentration, which represents the concentration of Fe in the margin regions Rm of the dielectric layers 11, is higher than a first concentration, which represents the concentration of Fe in the capacitance region (Rc) of the dielectric layers 11. This can promote densification of the dielectric layers 11 in the margin regions Rm without degrading the insulation reliability of the laminated ceramic capacitor 1. In this specification, the concentration of Fe in a portion of the dielectric layers 11 that is included in the capacitance region Rc may be referred to as “the first concentration,” and the concentration of Fe in a portion of the dielectric layers 11 that is included in the margin regions Rm may be referred to as “the second concentration.” In this specification, the concentration of Fe in the dielectric layers 11 means the atomic ratio of Fe with respect to 100 at % Ti.

The Fe concentration in the lead-out regions Ra may be lower than the Fe concentration in the margin regions Rm (the second concentration). The Fe concentration in the lead-out regions Ra may be higher than the Fe concentration in the capacitance region Rc. In this specification, the concentration of Fe in a portion of the dielectric layers 11 that is included in the lead-out regions Ra may be referred to as “the third concentration.” In the lead-out regions Ra, the firing is more difficult to proceed than in the capacitance region Rc and less difficult than in the margin regions Rm. Therefore, the third concentration is preferably higher than the first concentration and lower than the second concentration.

The first concentration in the capacitance region Rc may denote the Fe concentration at a measurement position P1 that is located within the capacitance region Rc of the dielectric layers 11. The measurement position P1 may be set, for example, on the intersection of (i) a first imaginary plane parallel to the LW plane and passing through the center of the body 10 in the T-axis direction and (ii) a second imaginary plane parallel to the LT plane and passing through the position a certain distance inward from the boundary between the capacitance region Rc and the second margin region Rm2 to the inside, where the certain distance is equal to a quarter of the dimension in the W-axis direction of the capacitance region Rc.

The second concentration in the margin regions Rm may denote the Fe concentration at a measurement position P2 that is located within the margin regions Rm of the dielectric layers 11. The measurement position P2 may be set, for example, on the intersection of (i) the first imaginary plane parallel to the LW plane and passing through the center of the body 10 in the T-axis direction and (ii) a third imaginary plane parallel to the LT plane and passing through the center of the second margin region Rm2 in the W-axis direction. The measurement position P2 may be set, for example, on the intersection of (i) the first imaginary plane parallel to the LW plane and passing through the center of the body 10 in the T-axis direction and (ii) a fourth imaginary plane parallel to the LT plane and passing through the center of the first margin region Rm1 in the W-axis direction.

The first and second concentrations can be measured using LA-ICP-MS (laser ablation inductively coupled plasma mass spectrometry). The first and second concentrations may be quantified using STEM (scanning transmission electron microscope)-EDS (energy dispersive X-ray spectrometer) analysis, EPMA (electron probe micro-analyzer) analysis, or other known analytical methods.

According to the present embodiment, sintering can be promoted in the margin regions Rm by the Fe contained in the margin regions Rm at the second concentration, which is higher than the first concentration. In this way, the portion of the dielectric layers 11 that is included in the margin regions Rm can be densified without increasing the sintering temperature. This can successfully densify the portion of the dielectric layers 11 that is included in the margin regions Rm without impairing the insulation reliability of the laminated ceramic capacitor 1.

If the Fe content in the margin regions Rm is too low, Fe fails to sufficiently promote sintering. Therefore, the margin regions Rm preferably have a sufficiently high Fe concentration to effectively promote sintering. In one aspect, the second concentration is set at 0.4 at % or higher.

When the first concentration is comparable to the second concentration, the sintering of the dielectric layers 11 is promoted by the Fe contained in the first concentration not only in the margin regions Rm but also in the capacitance region Rc. In the capacitance region Rc, the sintering is promoted by Ni. If the sintering in the capacitance region Rc is further promoted by Fe, the dielectric layers 11 may become excessively sintered in the capacitance region Rc. This may inadvertently lead to reduced insulation reliability. Therefore, there is preferably a significant difference between the second concentration and the first concentration in order to promote sintering in the margin regions Rm while ensuring the insulation reliability of the laminated ceramic capacitor 1. For this reason, the difference between the second concentration and the first concentration is set at 0.3 at % or greater in one aspect.

Since the internal electrode layers are opposed to each other in the capacitance region Rc, it is desirable to prevent generation of oxygen defects in the capacitance region Rc. In order to prevent generation of oxygen defects in the capacitance region Rc, the Fe content in the capacitance region Rc is preferably low. Therefore, the first concentration is set at less than 0.4 at % in one aspect.

### (1-7) Concentration of Sintering Agent

When the precursor of the dielectric layers 11 is fired, at least one of Mg or Mn can be added to the precursor as a sintering agent. While the sintering agent promotes densification of the dielectric layers 11, Mg and Mn may diffuse into the capacitance region Rc and cause a decrease in the capacitance of the laminated ceramic capacitor 1. Therefore, the concentration of Mg and Mn in the dielectric layers 11 preferably falls in such a range that sintering can be effectively promoted in the margin regions Rm while ensuring high capacitance of the laminated ceramic capacitor 1. In one aspect, the total concentration of Mg and Mn in the margin regions Rm is not less than 0.3 at % and less than 1.1 at %. In one aspect, the total concentration of Mg and Mn in the margin regions Rm is not less than 0.3 at % and less than 1.02 at %.

### (2) Manufacturing Method of Laminated Ceramic Capacitor 1

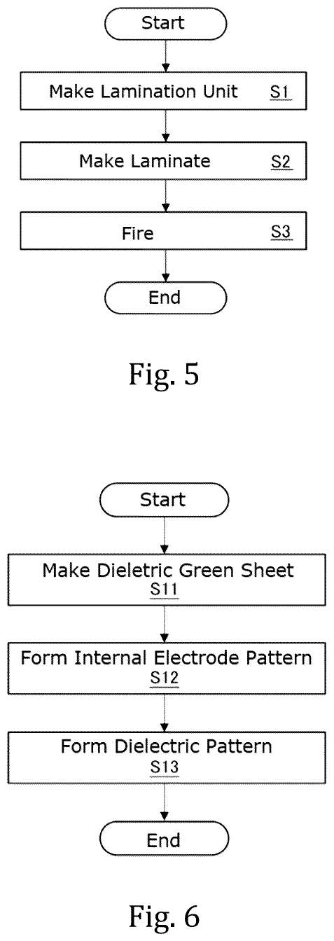

A description will now be given of a summary of the manufacturing method of the laminated ceramic capacitor 1 with reference to FIGS. 5 and 6. FIG. 5 is a flowchart showing a flow of a manufacturing method of a laminated ceramic capacitor according to one embodiment of the disclosure. FIG. 6 is a flow chart showing a method of forming a lamination unit.

In the step S1 of FIG. 5, a plurality of lamination units U1 are made. A description will now be given of the manufacturing method of each lamination unit U1 with reference to FIGS. 6, 7A to 7C, and 8A to 8B.

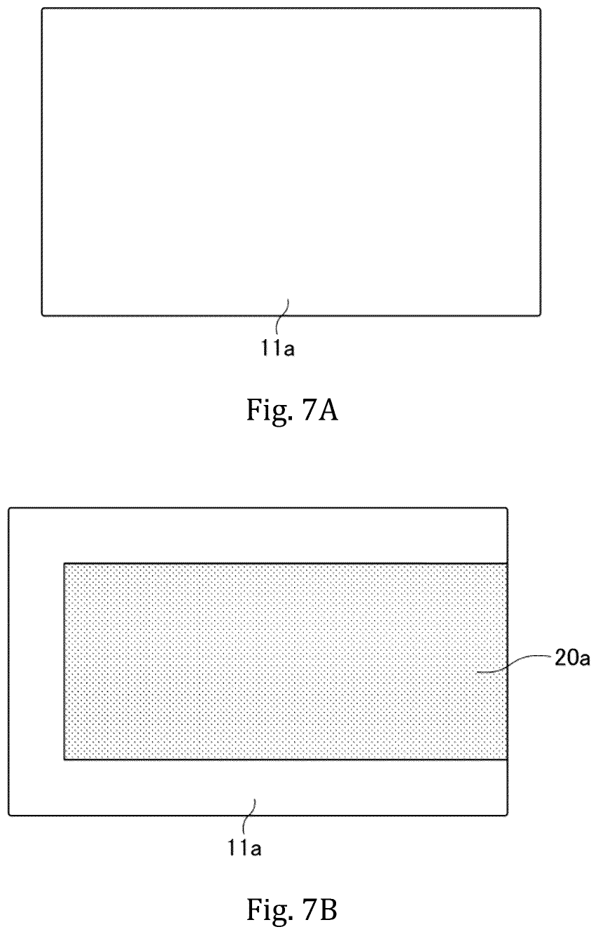

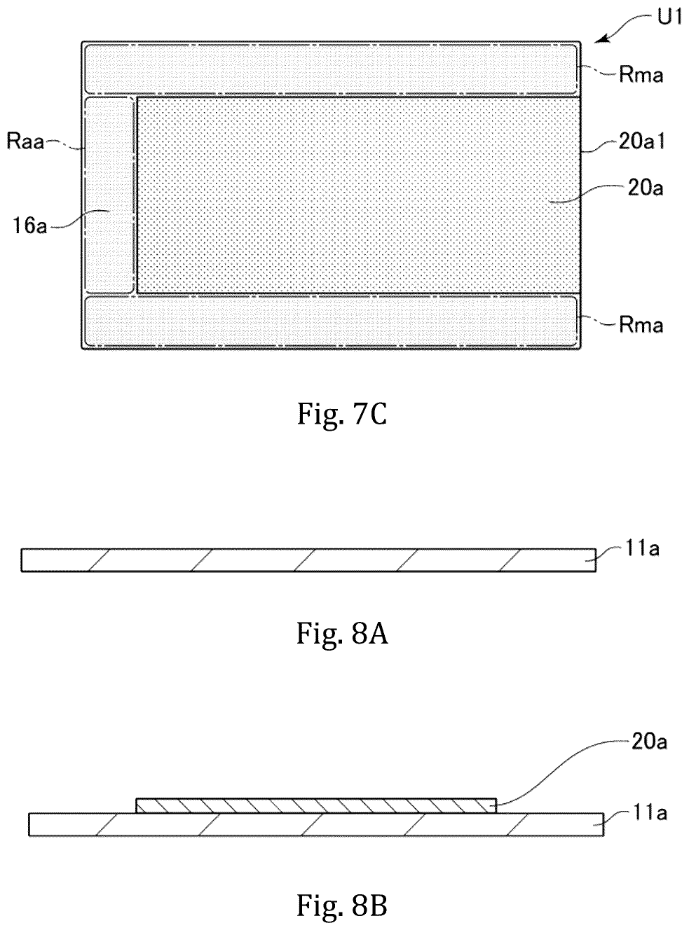

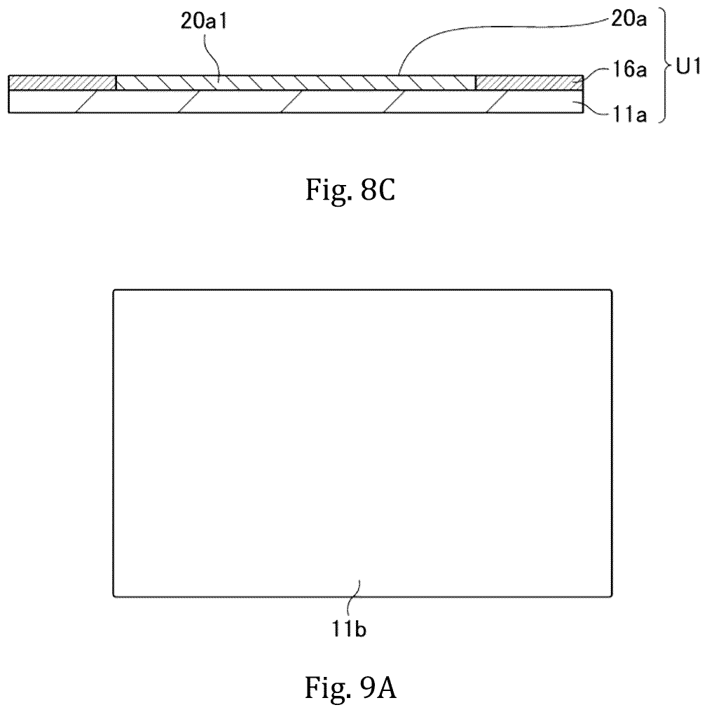

First, in the step S11 of FIG. 6, dielectric powder is wet-mixed with a binder such as polyvinyl butyral (PVB) resin, an organic solvent such as ethanol or toluene, and a plasticizer to obtain a slurry. This slurry is coated on a substrate film using, for example, the die coater or doctor blade method, and then the slurry coated on the substrate film is dried, to obtain a dielectric green sheet. FIGS. 7A and 8A show a dielectric green sheet 11a manufactured in the above-described manner. FIGS. 7A and 8A show a portion of the dielectric green sheet 11a manufactured in the above-described manner that corresponds to a single chip. FIG. 7A is a plan view showing the dielectric green sheet 11a for a single chip. FIG. 8A is a side view of the green sheet 11a shown in FIG. 7A as seen from the right side of the page.

The dielectric powder used as the raw powder of the dielectric green sheet is, for example, barium titanate (BaTiO₃) powder. Barium titanate powder is synthesized by reacting titanium raw material such as titanium dioxide with barium raw material such as barium carbonate by a known method such as the solid phase method, the sol-gel method, or the hydrothermal method.

Subsequently, in the step S12, an internal electrode pattern 20a is formed on a partial area of the top surface of the dielectric green sheet 11a, as illustrated in FIGS. 7B and 8B. The internal electrode pattern 20a is the precursor of each first internal electrode layer 21. FIG. 7B is a plan view of the dielectric green sheet 11a having the internal electrode pattern 20a formed thereon for one chip, and FIG. 8B is a side view showing the green sheet 11a shown in FIG. 7B as seen from the right side of the page. The internal electrode pattern 20a is formed, for example, by printing a paste for the internal electrodes on the dielectric green sheet 11a using screen printing or other known printing methods. The paste for the internal electrodes is produced by kneading and mixing a metal powder, a binder resin, and a solvent by a three-roll mill. In other words, the paste for the internal electrodes is a binder resin containing a metal powder dispersed therein. The metal powder contained in the paste for the internal electrodes encompasses powders of base metals such as Ni, Cu, and Sn, which are the main component of the first and second internal electrode layers 21 and 22. The organic binder used in the paste for the internal electrodes may be a cellulose-based resin such as ethyl cellulose or an acrylic resin such as butyl methacrylate.

The internal electrode pattern 20a may be formed on the dielectric green sheet by the sputtering method. The method of forming the internal electrode pattern is not limited to that specified herein. The internal electrode pattern may be formed by various known methods, e.g., vacuum deposition, PLD (pulsed laser deposition), MO-CVD (metal organic chemical vapor deposition), MOD (metal organic decomposition), or CSD (chemical solution deposition).

Subsequently, in the step S13, a dielectric pattern 16a is formed on an area of the top surface of the dielectric green sheet 11a where the internal electrode pattern 20a is not formed, as illustrated in FIGS. 7C and 8C. In this way, the lamination unit U1 is made. In the lamination unit U1, the dielectric pattern 16a is formed on the dielectric green sheet 11a such that the internal electrode pattern 20a has an exposed surface 20a1 that is not covered by the dielectric pattern 16a when viewed in plan view. For example, as shown in FIG. 7C, the dielectric pattern 16a covers the upper, lower, and left sides of the internal electrode pattern 20a as viewed in plan view, but not the right side of the internal electrode pattern 20a. The dielectric pattern 16a is formed, for example, by printing a paste for the dielectric pattern on the dielectric green sheet 11a using screen printing or other known printing methods.

The dielectric pattern 16a formed on the dielectric green sheet 11a is partitioned into margin regions Rma and an end region Raa. The margin regions Rma are opposed to each other with the internal electrode pattern 20a being arranged therebetween, and the end region Raa connects the opposing margin regions Rma. After fired, the margin regions Rma are processed into the portions of the dielectric layer 11 that are included in the margin regions Rm of the laminated ceramic capacitor 1. After fired, the end region Raa is processed into the portion of the dielectric layer 11 that is included in the lead-out regions Ra of the laminated ceramic capacitor 1.

The paste for the dielectric pattern is obtained by wet-mixing a powder mixture of a dielectric powder and an Fe-containing powder with a binder such as polyvinyl butyral (PVB) resin, an organic solvent such as ethanol or toluene, and a plasticizer. The Fe-containing powder is, for example, ferric oxide (Fe₂O₃) powder. The powder mixture may be produced, for example, by mixing 100 mol of BaTiO₃powder with from 0.6 to 1.8 mol of Fe₂O₃powder. The powder mixture can contain at least one of magnesium oxide (MgO) powder or manganese dioxide (MnO₂) powder.

The margin regions Rma may be formed from a different dielectric pattern paste than the end region Raa. The margin regions Rma may be formed from a first dielectric pattern paste, and the end region Raa may be formed from a second dielectric pattern paste. To make the Fe concentration higher in the margin regions Rm than in the lead-out region Ra in the laminated ceramic capacitor 1, the proportion of the Fe-containing powder may be set higher in the first dielectric pattern paste than in the second dielectric pattern paste.

In the above-described manner, the lamination unit U1 is produced. The lamination unit U1 has the dielectric green sheet 11a, the internal electrode pattern 20a formed on part of the top surface of the dielectric green sheet 11a, and the dielectric pattern 16a containing Fe-containing powder and formed on the dielectric green sheet 11a so as to surround the internal electrode pattern 20a. Although FIGS. 7A to 7C and FIGS. 8A to 8C show the lamination unit U1 corresponding to a single chip for the sake of simplicity of illustration, lamination units U1 for a plurality of chips can be manufactured together.

The following now describes the method of manufacturing a lamination unit U2. The lamination unit U2 is fabricated in the same way as the lamination unit U1, following the flow shown in FIG. 6. A description will now be given of the manufacturing method of the lamination unit U2 with reference to FIGS. 6, 9A to 9C, and 10A to 10C.

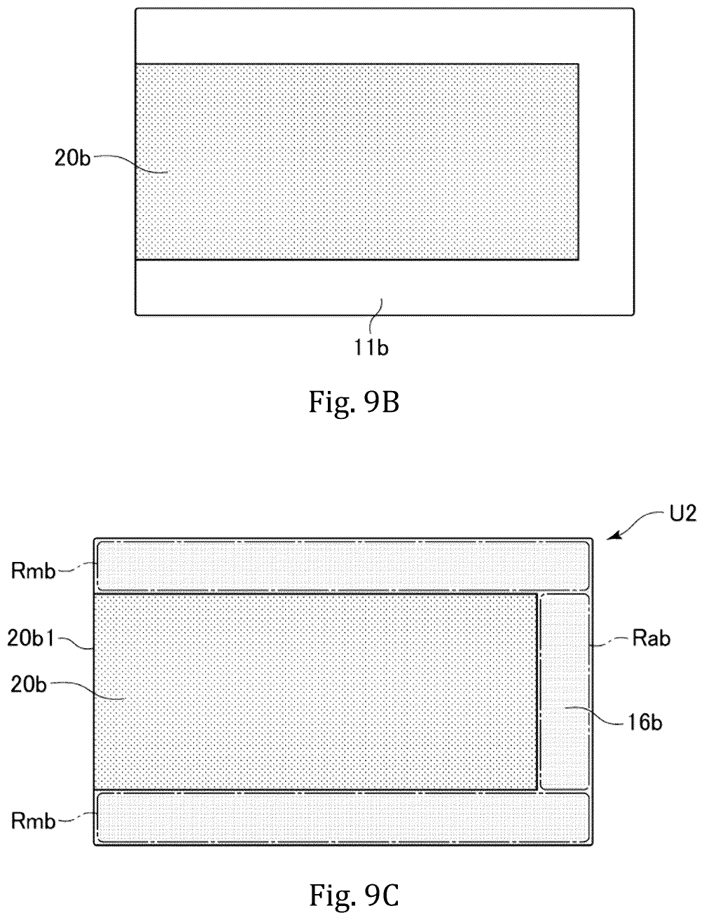

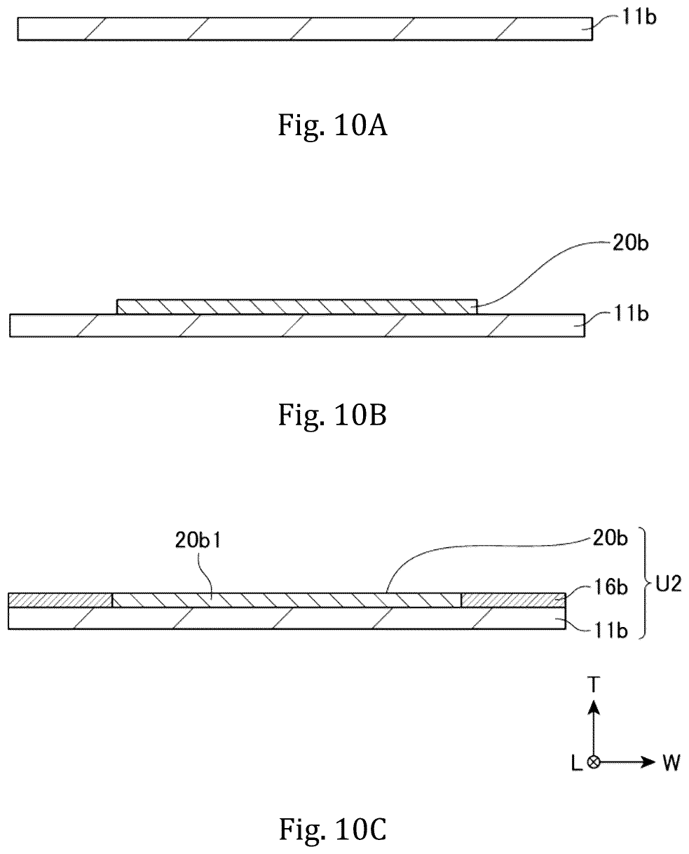

In the step S11 shown in FIG. 6, a dielectric green sheet 11b is fabricated. The dielectric green sheet 11b is prepared in the same way as the dielectric green sheet 11a. FIGS. 9A and 10A show the dielectric green sheet 11b manufactured in the above-described manner. FIGS. 9A and 10A show a portion of the dielectric green sheet 11b that corresponds to a single chip. FIG. 9A is a plan view showing the dielectric green sheet 11b for a single chip. FIG. 10A is a side view of the dielectric green sheet 11b shown in FIG. 9A as seen from the left side of the page.

Subsequently, in the step S12, an internal electrode pattern 20b is formed on a partial area of the top surface of the dielectric green sheet 11b, as illustrated in FIGS. 9B and 10B. FIG. 9B is a plan view of the dielectric green sheet 11b having the internal electrode pattern 20b formed thereon for one chip, and FIG. 10B is a side view showing the dielectric green sheet 11b shown in FIG. 9B as seen from the left side of the page. The internal electrode pattern 20b is the precursor of each second internal electrode layer 22. The internal electrode pattern 20b is manufactured in the same way as the internal electrode pattern 20a.

Subsequently, in the step S13, a dielectric pattern 16b is formed on an area of the top surface of the dielectric green sheet 11b where the internal electrode pattern 20b is not formed, as illustrated in FIGS. 9C and 10C. In this way, the lamination unit U2 is made. In the lamination unit U2, the dielectric pattern 16b is formed on the dielectric green sheet 11b such that the internal electrode pattern 20b has an exposed surface 20b1 that is not covered by the dielectric pattern 16b when viewed in plan view. For example, as shown in FIG. 9C, the dielectric pattern 16b covers the upper, lower, and right sides of the internal electrode pattern 20b as viewed in plan view, but not the left side of the internal electrode pattern 20b. The dielectric pattern 16b is formed, for example, by printing a paste for the dielectric pattern on the dielectric green sheet 11b using screen printing or other known printing methods. The dielectric pattern paste for the dielectric pattern 16b can be the same as the dielectric pattern paste for the dielectric pattern 16a.

The dielectric pattern 16b formed on the dielectric green sheet 11b is partitioned into margin regions Rmb and an end region Rab. The margin regions Rmb are opposed to each other with the internal electrode pattern 20b being arranged therebetween, and the end region Rab connects the opposing margin regions Rmb. After fired, the margin regions Rmb are processed into the portions of the dielectric layer 11 that are included in the margin regions Rm of the laminated ceramic capacitor 1. After fired, the end region Rab is processed into the portion of the dielectric layer 11 that is included in the lead-out regions Ra of the laminated ceramic capacitor 1.

In the above-described manner, the lamination unit U2 is produced. The lamination unit U2 has the dielectric green sheet 11b, the internal electrode pattern 20b formed on part of the top surface of the dielectric green sheet 11b, and the dielectric pattern 16b containing Fe-containing powder and formed on the dielectric green sheet 11b so as to surround the internal electrode pattern 20b. Although FIGS. 9A to 9C and FIGS. 10A to 10C show the lamination unit U2 corresponding to a single chip for the sake of simplicity of illustration, lamination units U2 for a plurality of chips can be manufactured together.

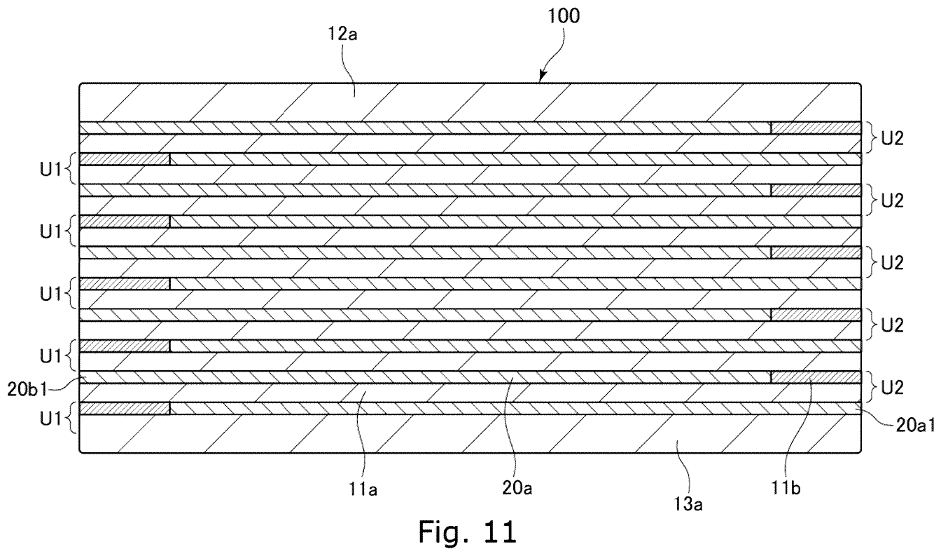

Subsequently, in the step S2 of FIG. 5, a plurality of lamination units U1 and a plurality of lamination units U2 are alternately stacked, a dielectric green sheet 12a is provided as the top layer, and a dielectric green sheet 13a is provided as the bottom layer. In this manner, a laminate is obtained. In the laminate, the exposed surfaces 20a1 of the internal electrode patterns 20a and the exposed surfaces 20b1 of the internal electrode patterns 20b are alternately exposed on the right and left sides. The dielectric green sheet 12a is the precursor of the upper cover layer 12, and the dielectric green sheet 13a is the precursor of the lower cover layer 13. Next, the laminate is diced into pieces to obtain chip laminates 100 shaped like a chip each being the precursor of the body 10. An example of the chip laminate 100 is shown in FIG. 11. FIG. 11 is a sectional view of the chip laminate 100 along the LT plane. As illustrated in the drawing, in the chip laminate 100, the lamination units U1 and U2 are stacked such that the exposed surfaces 20a1 and 20b1 are alternately exposed on the right and left sides.

The chip laminate 100 may be then subjected to degreasing. The degreasing process may be performed in an N₂ atmosphere. The chip laminate having undergone the degreasing process may be coated with a metal paste by the dip method to form base layers of the first and second external electrodes 31 and 32. The first and second external electrodes 31 and 32 may be formed by, after a firing process (step S3) described below is performed on the laminate, applying metal paste to the fired laminate by the dip method, and then baking the metal paste.

Next, in the step S3, the chip laminate 100 produced in the step S2 is placed into a firing furnace and fired in this furnace. In the firing furnace, a low oxygen atmosphere with an oxygen partial pressure of 10⁻⁹ to 10⁻¹¹ atm is maintained, for example. Prior to the firing, the laminate 100 may be preheated at a predetermined preheating temperature for 10 minutes to 1 hour. The preheating temperature is, for example, 500° C. After the preheating, the temperature in the firing furnace is raised to the firing temperature at a fast rate, and the chip laminate 100 is fired at this firing temperature for 1 to 5 minutes. The firing temperature is, for example, 1100 to 1300° C. The temperature increase rate is, for example, 4000 to 10000° C./h.

As a result of the firing in the step S3, the chip laminate 100 is fired and the laminated ceramic capacitor 1 can be obtained.

During the firing process, the temperature is raised at a high rate of 4000 to 10000° C./h. This can prevent the diffusion of the Fe contained in the dielectric patterns 16a and 16b into the capacitance region Rc.

Processes not shown in the flowchart of FIG. 6 may be performed to produce the laminated ceramic capacitor 1. For example, the laminated ceramic capacitor 1 obtained through the firing process in the step S3 may be subjected to re-oxidation treatment at 600° C. to 1000° C. in an N₂ gas atmosphere. A plating layer of Cu, Ni, Sn or the like may be provided on the surfaces of the first and second external electrodes 31 and 32. This plating layer can be formed by the electrolytic or electroless plating method.

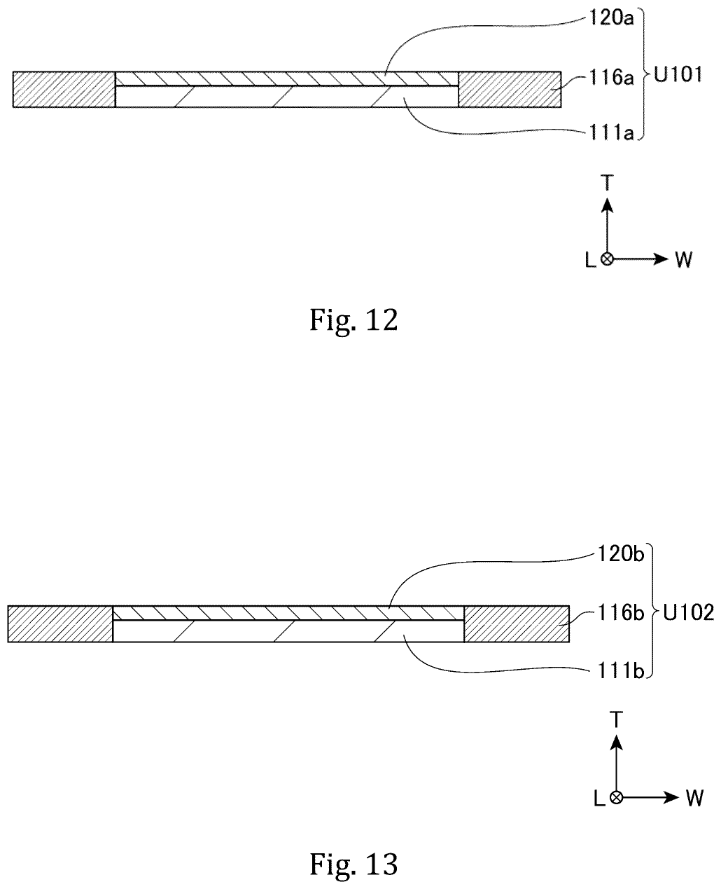

The lamination units U1 constituting the laminate 100 may be configured in any other manner than shown in FIGS. 7C and 8C. FIG. 12 shows a lamination unit U101 relating to a different embodiment. FIG. 12 shows the lamination unit U101 from the same perspective as FIG. 8C. As shown in FIG. 12, the lamination unit U101 has a dielectric green sheet 111a, an internal electrode pattern 120a formed on the top surface of the dielectric green sheet 111a, and a dielectric pattern 116a surrounding the dielectric green sheet 111a and the internal electrode pattern 120a. The lamination unit U101 differs from the lamination unit U1 in that the dielectric pattern 116a is formed not on the top surface of the dielectric green sheet 111a but around the dielectric green sheet 111a. Except for the position of the dielectric pattern 116a, the description for the lamination unit U1 also applies to the lamination unit U101.

The lamination units U2 constituting the laminate 100 may be configured in any other manner than shown in FIGS. 9C and 10C. FIG. 13 shows a lamination unit U102 relating to a different embodiment. FIG. 13 shows the lamination unit U102 from the same perspective as FIG. 10C. As shown in FIG. 13, the lamination unit U102 has a dielectric green sheet 111b, an internal electrode pattern 120b formed on the top surface of the dielectric green sheet 111b, and a dielectric pattern 116b surrounding the dielectric green sheet 111b and the internal electrode pattern 120b. The lamination unit U102 differs from the lamination unit U2 in that the dielectric pattern 116b is formed not on the top surface of the dielectric green sheet 111b but around the dielectric green sheet 111b. Except for the position of the dielectric pattern 116b, the description for the lamination unit U2 also applies to the lamination unit U102.

Some or all of the lamination units U1 constituting the chip laminate 100 may be replaced by the lamination units U101. Some or all of the lamination units U2 constituting the chip laminate 100 may be replaced by the lamination units U102.

### (3) Another Manufacturing Method for Chip Laminate

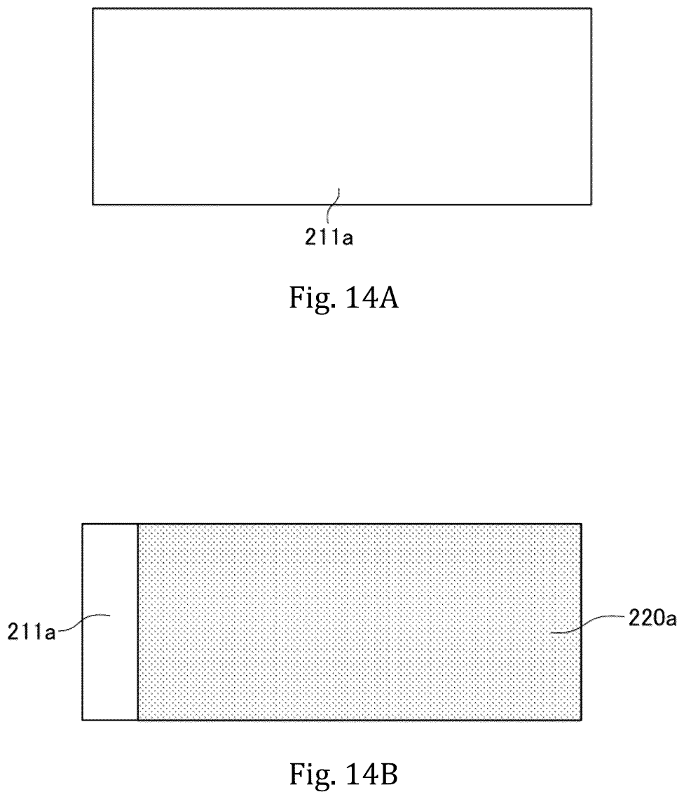

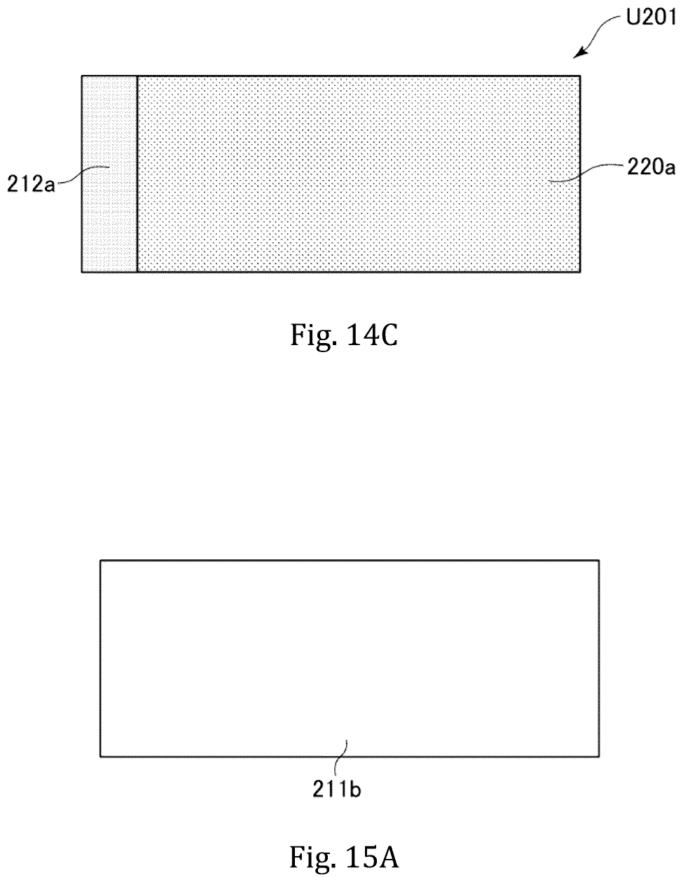

The following now describes another method of manufacturing the chip laminate, which is the precursor of the body 10, with reference to FIGS. 14A to 14C, 15A to 15C, and 16A to 16B.

First, a dielectric green sheet 211a is made, as shown in FIG. 14A. The dielectric green sheet 211a is made in the same way as the dielectric green sheet 11a. FIG. 14A shows the dielectric green sheet 211a in plan view.

Subsequently, an internal electrode pattern 220a is formed on a partial area of the top surface of the dielectric green sheet 211a, as illustrated in FIG. 14B. FIG. 14B is a plan view showing the dielectric green sheet 211a having the internal electrode pattern 220a formed thereon for a single chip. The internal electrode pattern 220a is the precursor of each first internal electrode layer 21. The internal electrode pattern 220a is manufactured in the same way as the internal electrode pattern 20a. The internal electrode pattern 220a is formed on the top surface of the dielectric green sheet 211a so as to cover the entire region of the dielectric green sheet 211a except for the left edge portion on the page.

Subsequently, as illustrated in FIG. 14C, a dielectric pattern 212a is formed on an area of the top surface of the dielectric green sheet 211a where the internal electrode pattern 220a is not formed. In this way, the lamination unit U201 is made. The dielectric pattern paste for the dielectric pattern 212a can be the same as the dielectric pattern paste for the dielectric pattern 16a.

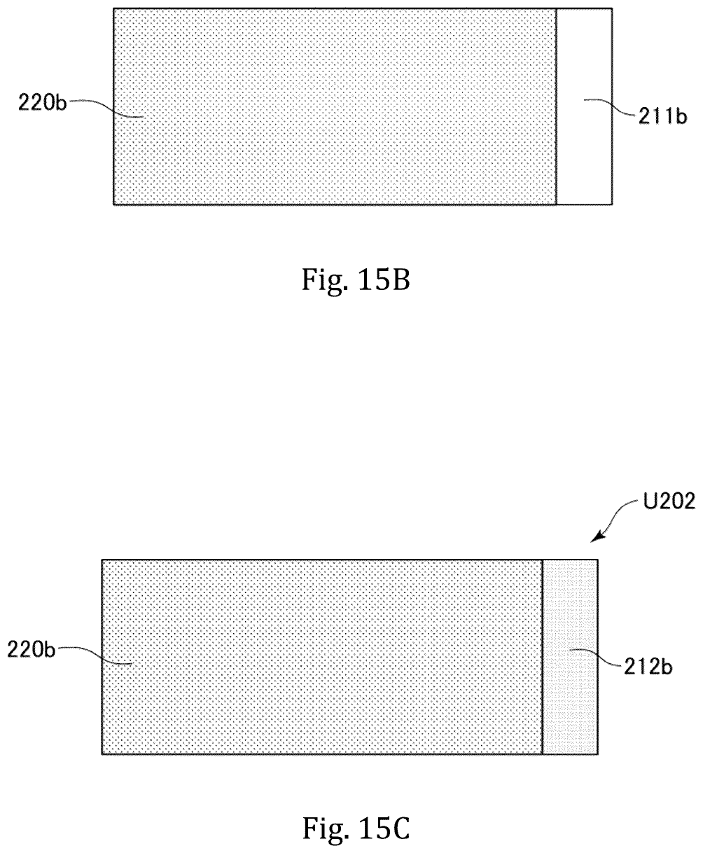

Subsequently, a dielectric green sheet 211b is made, as shown in FIG. 15A. The dielectric green sheet 211b is made in the same way as the dielectric green sheet 11a. FIG. 15A shows the dielectric green sheet 211b in plan view.

Subsequently, an internal electrode pattern 220b is formed on a partial area of the top surface of the dielectric green sheet 211b, as illustrated in FIG. 15B. FIG. 15B is a plan view showing the dielectric green sheet 211b having the internal electrode pattern 220b formed thereon for a single chip. The internal electrode pattern 220b is the precursor of each second internal electrode layer 22. The internal electrode pattern 220b is manufactured in the same way as the internal electrode pattern 20b. The internal electrode pattern 220b is formed on the top surface of the dielectric green sheet 211b so as to cover the entire region of the dielectric green sheet 211b except for the right edge portion on the page.

Subsequently, as illustrated in FIG. 15C, a dielectric pattern 212b is formed on an area of the top surface of the dielectric green sheet 211b where the internal electrode pattern 220b is not formed. In this way, a lamination unit U202 is made. The dielectric pattern paste for the dielectric pattern 212b can be the same as the dielectric pattern paste for the dielectric pattern 16a.

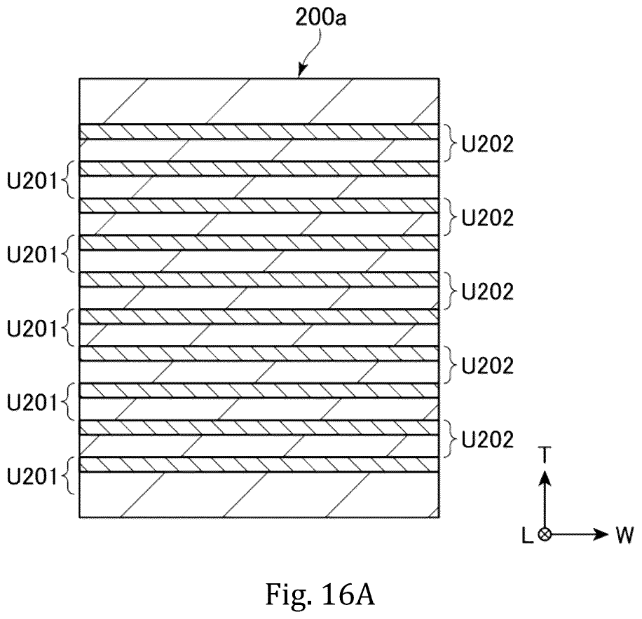

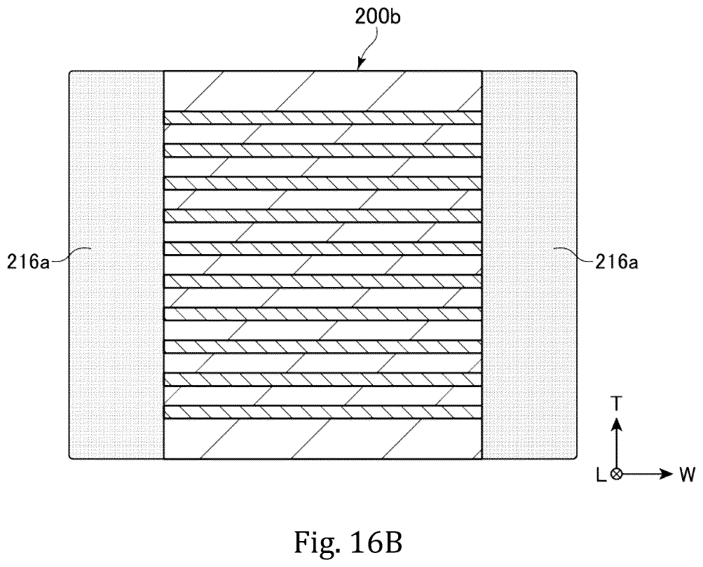

Subsequently, a plurality of lamination units U201 and a plurality of lamination units U202 are alternately stacked, a dielectric green sheet 12a is provided as the top layer, and a dielectric green sheet 13a is provided as the bottom layer. In this manner, a laminate 200a is obtained. FIG. 16A shows a section of the laminate 200a along a plane that is parallel to the WT plane. If the laminate 200a is cut in a plane parallel to the LT plane, the exposed surfaces of the internal electrode patterns 220a and the exposed surfaces of the internal electrode patterns 220b are exposed alternately from the opposing ends of the laminate 200a in the L-axis direction, like the laminate 100 shown in FIG. 11.

Next, as shown in FIG. 16B, dielectric compacts 216a are attached to the opposing ends of the laminate 200a in the W-axis direction. In this way, a laminate 200b is fabricated. The dielectric compacts 216a are the precursor of the portions of the dielectric layers 11 that correspond to the margin regions Rm. The dielectric compacts 216a are made by molding dielectric paste into a rectangular parallelepiped shape. The dielectric paste used as the raw material for the dielectric compacts 216a may be the same as the paste for the dielectric pattern 16a. The dielectric paste used as the raw material for the dielectric compacts 216a is obtained by wet-mixing a powder mixture of a dielectric powder and an Fe-containing powder with a binder such as polyvinyl butyral (PVB) resin, an organic solvent such as ethanol or toluene, and a plasticizer. The Fe-containing powder is, for example, ferric oxide (Fe₂O₃) powder. The powder mixture may be produced, for example, by mixing 100 mol of BaTiO₃ powder with from 0.6 to 1.8 mol of Fe₂O₃ powder. The powder mixture can contain at least one of magnesium oxide (MgO) powder or manganese dioxide (MnO₂) powder. The dielectric compacts 216a are made from the above-mentioned dielectric paste by means of compression molding.

The laminate 200b made in the above-described manner is fired in the same manner as the laminate 100, as a result of which the laminated ceramic capacitor 1 is obtained.

### (4) Examples

The invention will now be further described in detail based on examples. The invention is not limited to the following examples.

### (4-1) Preparation of Samples

To begin with, 24 different samples were prepared according to the manufacturing method shown in FIGS. 5 and 6, as follows. A slurry was first obtained by wet-mixing barium titanate powder with polyvinyl butyral (PVB) resin, a solvent, and a plasticizer. The slurry was coated on a substrate film, and then the slurry coated on the substrate film was dried to obtain a dielectric green sheet. Next, Ni powder was wet-mixed with polyvinyl butyral (PVB) resin, a solvent, and a plasticizer to obtain a slurry for the internal electrodes. Then, the slurry for the internal electrodes was printed on a part of the surface of each dielectric green sheet, to form an internal electrode pattern on the dielectric green sheet.

Following this, dielectric paste was applied to an area of the surface of the dielectric green sheet where the internal electrode pattern was not formed, to form a dielectric pattern. For the preparation of the dielectric paste for each sample, Fe₂O₃ powder, MgO powder, and MnO₂ powder were weighed in proportions corresponding to those given in Table 1, relative to 100 mol of BaTiO₃ powder. Table 1 shows the amounts of the respective powders added for each sample. These weighed powders were mixed and ground using zirconia beads having a diameter of 1 mm, to obtain the raw material powder for the dielectric pattern. Next, the raw material powder was wet-mixed with polyvinyl butyral (PVB) resin, a solvent, and a plasticizer, to obtain the dielectric paste. The obtained dielectric paste was applied to an area of the top surface of the dielectric green sheet where the internal electrode pattern was not formed, to form the dielectric pattern. In this way, lamination units U1 and U2 were formed. The lamination units U1 and U2 each have the dielectric green sheet, the internal electrode pattern formed on part of the top surface of the dielectric green sheet, and the dielectric pattern formed on a portion of the surface of the dielectric green sheet where the internal electrode pattern is not formed, as shown in FIGS. 7C, 8C, 9C and 10C.

Next, 500 lamination units were stacked together to form a laminate, which was then diced into chip laminates. The lamination units were stacked such that the internal electrode patterns were exposed alternately on the left and right sides, as shown in FIG. 11. The chip laminates had the 1005 shape (length: 1.0 mm, width: 0.5 mm, height: 0.5 mm). Next, these chip-shaped compacts were degreased in an N₂ atmosphere. Following this, metal paste was applied to the degreased compacts by the dip method, to form base layers of the external electrodes on the compacts.

Next, the chip laminates obtained as described above, or the precursors of the samples, were put into a firing furnace. The chip laminates were preheated at 500° C. and for 30 minutes within a low oxygen atmosphere with an oxygen partial pressure of 10⁻⁹ to 10⁻¹⁰ atm maintained in the firing furnace. After the preheating, the temperature in the firing furnace was raised to the firing temperature shown in Table 1 at the temperature increase rate shown in Table 1, and the chip laminates were fired at the resulting firing temperature for 3 minutes. The conditions for firing the respective samples were determined such that the degree of sintering (the sintering progress) in the capacitance region Rc was approximately identical among the samples (specifically, all of the samples had capacitance of approximately 10 μF as a result of firing). The following compares and evaluates, in terms of the degree of sintering in the margin regions, samples 1 to 24 that have an approximately identical degree of sintering in the capacitance region as a result of the above-described series of steps.

TABLE 1

| | | | | Firing | Temperature |
|---|---|---|---|---|---|
| | Fe₂O₃ | MgO | MnO₂ | Temperature | Increase Rate |
| | (mol) | (mol) | (mol) | (° C.) | (° C./h) |
| Sample 1 | 0.6 | 0.2 | 0.2 | 1240 | 5000 |
| Sample 2 | 0.6 | 0.2 | 0.2 | 1260 | 4000 |
| Sample 3 | 1.1 | 0.2 | 0.2 | 1215 | 5000 |
| Sample 4 | 1.1 | 0.2 | 0.2 | 1255 | 4000 |
| Sample 5 | 1.8 | 0.2 | 0.2 | 1175 | 5000 |
| Sample 6 | 1.8 | 0.2 | 0.2 | 1245 | 4000 |
| Sample 7 | 2 | 0.2 | 0.2 | 1170 | 5000 |
| Sample 8* | 0 | 0.2 | 0.2 | 1285 | 5000 |
| Sample 9 | 0.6 | 0.6 | 0.6 | 1230 | 5000 |
| Sample 10 | 0.6 | 0.6 | 0.6 | 1250 | 4000 |
| Sample 11 | 1.1 | 0.6 | 0.6 | 1200 | 5000 |
| Sample 12 | 1.1 | 0.6 | 0.6 | 1240 | 4000 |
| Sample 13 | 1.8 | 0.6 | 0.6 | 1160 | 5000 |
| Sample 14 | 1.8 | 0.6 | 0.6 | 1230 | 4000 |
| Sample 15 | 2 | 0.6 | 0.6 | 1160 | 5000 |
| Sample 16* | 0 | 0.6 | 0.6 | 1270 | 5000 |
| Sample 17 | 0.6 | 0.7 | 0.7 | 1230 | 5000 |
| Sample 18 | 1.8 | 0.7 | 0.7 | 1170 | 5000 |
| Sample 19 | 0.6 | 0.4 | 0.4 | 1235 | 5000 |
| Sample 20 | 0.6 | 0.4 | 0.4 | 1260 | 4000 |
| Sample 21 | 1.1 | 0.4 | 0.4 | 1210 | 5000 |
| Sample 22 | 1.1 | 0.4 | 0.4 | 1250 | 4000 |
| Sample 23 | 1.8 | 0.4 | 0.4 | 1170 | 5000 |
| Sample 24 | 1.8 | 0.4 | 0.4 | 1240 | 4000 |

In samples 1 to 24, the dielectric green sheets and dielectric patterns were fired into the dielectric layers, and the internal electrode patterns were fired into the internal electrode layers. The base layers formed on the compacts were fired to form the external electrodes. Therefore, samples 1 to 24 are all laminated ceramic capacitors in which the dielectric layers and internal electrode layers are arranged alternately along the T-axis direction.

### (4-2) Moisture Resistance Test

Moisture resistance test was performed on each of samples 1 to 24. Specifically, for each of samples 1 to 24, 500 pieces were selected and subjected to a moisture resistance test under the following conditions: test temperature=40° C., relative humidity=95% RH, applied voltage=10 Vdc (direct current), and time=500 hours, after which the pieces were immediately taken out of the moisture resistance chamber. Once the temperature went back to the room temperature, the resistance value of each piece was measured. Pieces having a resistance value less than 25 Mil were determined to be defective in moisture resistance, and the defective fraction was examined. The results of the moisture resistance test showed that the defective fractions were 0% for all of samples 1 to 24. It was thus concluded that samples 1 to 24 had excellent moisture resistance.

### (4-3) Measuring of Concentration

Next, the concentrations of Fe, Mg, and Mn in each sample were measured. Specifically, samples 1 to 24 were polished so that the LT plane would be used as the observation surface and then transported into a laser ablation apparatus with the observation surface being exposed. Subsequently, the apparatus irradiated a laser onto the observation surface of each sample targeting approximately a measurement position P1 in the capacitance region and a measurement position P2 in the margin regions Rm, in order to measure the concentrations of Ba, Ti, Fe, Mn, and Mg at the respective laser-irradiated sites. The laser ablation apparatus was an NWR213 available from Elemental Scientific Lasers, and the inductively coupled plasma mass spectrometer was an Agilent 7900 ICP-MS available from Agilent Technologies. The Fe concentration measured in the above-described manner approximately at the measurement position P1 in the capacitance region is listed in the “First Fe Concentration (at %)” column in Table 2. The first Fe concentration in Table 2 corresponds to the first concentration representing the concentration of Fe in the capacitance region Rc. The Fe concentration measured approximately at the measurement position P2 in the margin regions Rm is listed in the “Second Fe concentration (at %)” column in Table 2. The second Fe concentration in Table 2 corresponds to the second concentration representing the Fe concentration in the margin regions Rm. In addition, the difference between the second Fe concentration and the first Fe concentration was determined, and is listed in the “Difference in Fe Concentration” column in Table 2. The total of the Mn concentration and the Mg concentration measured approximately at the measurement position P2 is listed in the “(Mn+Mg) Concentration (at %)” column in Table 2. The concentrations of Fe, Mn, and Mg are expressed as atomic ratios relative to 100 at % Ti, respectively.

### (4-4) Capacitance

The capacitance was measured for each of samples 1 to 24. The capacitance was measured using an LCR meter with an AC applied voltage of 1 Vrms at 1 kHz. One hundred pieces were selected for each of samples 1 to 14, the capacitance was determined for each of these 100 pieces, and the average of the measured values were taken as the capacitance of each sample. The capacitance calculated in this way is listed in the “Capacitance (μF)” column in Table 2.

### (4-5) Halt

One hundred pieces were selected for each of samples 1 to 24, and an accelerated life test (HALT) was performed on each of these selected pieces. In the accelerated life test, a voltage of 15V/μm was applied at 125° C. to each of the 100 pieces selected for each of samples 1 to 24, and the time to failure was measured. The median value of the measured values for the 100 pieces is listed in the “HALT 50% value (min)” column in Table 2.

### (4-6) CR Product

One hundred pieces were selected for each of samples 1 to 24, a DC voltage of 10V was applied for one minute to each of the selected pieces, and insulation resistance IR was then measured using an insulation resistance tester. The average of the insulation resistance IR values calculated for these 100 pieces was used as the insulation resistance of each sample. The product of the insulation resistance and capacitance was then calculated for each sample. The product is listed in the “CR product (MfΩμF)” column in Table 2.

TABLE 2

| | First Fe | Second Fe | Difference in | (Mn + Mg) | | HALT 50% | |
|---|---|---|---|---|---|---|---|
| | Concentration | Concentration | Fe Concentration | Concentration | Capacitance | Value | CR Product |
| | (atm %) | (atm %) | (atm %) | (atm %) | (μF) | (min.) | (M Ω μF) |
| Sample 1 | 0.07 | 0.50 | 0.43 | 0.30 | 10.5 | 317 | 908 |
| Sample 2 | 0.11 | 0.43 | 0.32 | 0.30 | 10.6 | 278 | 888 |
| Sample 3 | 0.14 | 0.92 | 0.78 | 0.31 | 10.4 | 356 | 801 |
| Sample 4 | 0.31 | 0.69 | 0.38 | 0.32 | 10.7 | 256 | 655 |
| Sample 5 | 0.38 | 1.50 | 1.12 | 0.32 | 10.3 | 605 | 719 |
| Sample 6 | 0.62 | 1.11 | 0.49 | 0.31 | 10.5 | 298 | 399 |
| Sample 7 | 0.4 | 1.7 | 1.27 | 0.3 | 9.8 | 610 | 466 |
| Sample 8* | 0.0 | 0.0 | 0.00 | 0.3 | 10.8 | 189 | 823 |
| Sample 9 | 0.04 | 0.51 | 0.47 | 1.02 | 9.6 | 400 | 769 |
| Sample 10 | 0.11 | 0.43 | 0.32 | 1.02 | 10 | 276 | 844 |
| Sample 11 | 0.14 | 0.90 | 0.76 | 1.01 | 9.7 | 491 | 714 |
| Sample 12 | 0.30 | 0.68 | 0.37 | 1.00 | 9.8 | 281 | 573 |
| Sample 13 | 0.39 | 1.52 | 1.13 | 1.01 | 9.6 | 629 | 599 |
| Sample 14 | 0.63 | 1.12 | 0.49 | 1.01 | 9.5 | 333 | 429 |
| Sample 15 | 0.4 | 1.7 | 1.27 | 1.0 | 9.6 | 718 | 382 |
| Sample 16* | 0.0 | 0.0 | 0.00 | 1.0 | 9.9 | 254 | 652 |
| Sample 17 | 0.0 | 0.5 | 0.46 | 1.2 | 9.3 | 489 | 619 |
| Sample 18 | 0.3 | 1.5 | 1.16 | 1.2 | 9.4 | 621 | 419 |
| Sample 19 | 0.05 | 0.53 | 0.48 | 0.60 | 10.2 | 423 | 799 |
| Sample 20 | 0.12 | 0.45 | 0.33 | 0.61 | 10.3 | 289 | 798 |
| Sample 21 | 0.14 | 0.92 | 0.78 | 0.62 | 10.1 | 511 | 613 |
| Sample 22 | 0.31 | 0.69 | 0.38 | 0.60 | 10.2 | 269 | 607 |
| Sample 23 | 0.39 | 1.51 | 1.12 | 0.61 | 10.2 | 537 | 583 |
| Sample 24 | 0.62 | 1.12 | 0.49 | 0.62 | 9.9 | 342 | 411 |

In Table 2, the samples not encompassed by the present invention (i.e., comparative examples) have an asterisk (*) added to the sample number. Specifically, samples 8 and 16 are comparative examples not encompassed by the present invention.

### (4-7) Analysis

The characteristics of samples 1 to 7, in which the Fe concentration in the margin regions Rm (i.e., the second Fe concentration) is higher than the Fe concentration in the capacitance region Rc (i.e., the first Fe concentration), are compared against those of sample 8, which is made from the same raw materials except for the presence of Fe. This reveals that samples 1 to 7 all allow firing at lower temperatures than sample 8 and that samples 1 to 7 have a higher HALT 50% value than sample 8. The characteristics of samples 9 to 15, in which the Fe concentration in the margin regions Rm (i.e., the second Fe concentration) is higher than the Fe concentration in the capacitance region Rc (i.e., the first Fe concentration), are compared against those of sample 16, which is made from the same raw materials except for the presence of Fe. This reveals that samples 9 to 15 all allow firing at lower temperatures than sample 16 and that samples 9 to 15 have a higher HALT 50% value than sample 16. The results of the moisture resistance test have confirmed that the margin regions Rm are densified in the samples 1 to 7 and samples 9 to 15. Therefore, it has been confirmed that setting the second Fe concentration in the margin regions Rm higher than the first Fe concentration in the capacitance region Rc can lead to densification of the margin regions Rm without causing a decrease in the insulation reliability compared to the samples without Fe addition. If the first Fe concentration is set higher than the second Fe concentration, a lot of oxygen defects occur in the capacitance region Rc, and higher firing temperature is required to densify the margin regions Rm. Therefore, Fe is added such that the second Fe concentration is higher than the first Fe concentration.

The samples are further analyzed for their HALT 50% values. Comparing sample 1 with sample 2, the same amount of Fe₂O₃ powder was added to their raw materials, but sample 1 had a higher temperature increase rate than sample 2. Therefore, sample 1 has a greater difference in Fe concentration than sample 2. In addition, sample 1 has a higher HALT 50% value than sample 2. Sample 1 has a higher HALT 50% value than sample 2 probably for the following reason. Sample 1 has a greater difference in Fe concentration than sample 2 and the first concentration is thus lower in sample 1 than in sample 2, as a result which oxygen defects in the capacitance region Rc are prevented in sample 1 compared to sample 2. Similar to the comparison between samples 1 and 2, comparison is performed between samples 3 and 4, samples 5 and 6, samples 9 and 10, samples 11 and 12, samples 13 and 14, samples 19 and 20, samples 21 and 22, and samples 23 and 24. In any case, the HALT 50% value is greater in the sample that has a greater temperature increase rate and a greater difference in Fe concentration with the same amount of Fe added to the raw materials.

The foregoing results demonstrate the following. The laminated ceramic capacitor can be made by adding Fe to the dielectric layers 11 in such a manner that the second Fe concentration in the margin regions Rm becomes higher than the first Fe concentration in the capacitance region Rc. In this way, the margin regions Rm can be densified without causing a decrease in the insulation reliability of the laminated ceramic capacitor when compared with samples without Fe addition.

Judging from the relationship between the difference in Fe concentration and the HALT 50% value for samples 19 to 20 and Samples 23 to 24, the HALT 50% value increases more significantly relative to the increase in Fe concentration when the difference in Fe concentration is in the range of 0.33 to 0.49. This accordingly confirms that the samples having a difference in Fe concentration of 0.5 at % or greater have a sufficiently high HALT 50% value when compared with the samples with no Fe added, thereby achieving particularly high insulation reliability.

Comparing sample 1 with sample 2 indicates that, although the same amount of Fe₂O₃ powder is added to the raw materials, sample 1 has a lower firing temperature than sample 2, that is, sample 1 can be sintered at a lower firing temperature than sample 2. As for laminated ceramic capacitors, the margin regions Rm are more difficult to sinter than the capacitance region Rc. Therefore, the firing temperature of the laminated ceramic capacitors is limited by the sinterability in the margin regions Rm. As sample 1 can be sintered at a lower temperature than sample 2, the margin regions Rm of sample 1 can be sintered at a lower temperature than the margin regions Rm of sample 2. The margin regions Rm of sample 1 can be sintered at a lower temperature than the margin regions Rm of sample 2 for the following reasons. Since the difference in Fe concentration is greater in sample 1 than in sample 2, the second concentration is higher in sample 1 than in sample 2. As a result, the margin regions Rm of sample 1 have a higher Fe concentration and accordingly has higher sinterability than the margin regions Rm of sample 2. Similar comparison is performed between samples 3 and 4, samples 5 and 6, samples 9 and 10, samples 11 and 12, samples 13 and 14, samples 19 and 20, and samples 23 and 24. In any case, the firing temperature is lower in the sample that has a greater temperature increase rate and a greater difference in Fe concentration.

As described above, the laminated ceramic capacitor can be made by adding Fe to the dielectric layers 11 in such a manner that the second Fe concentration in the margin regions Rm becomes higher than the first Fe concentration in the capacitance region Rc. In this way, the margin regions Rm can be densified without causing an increase in firing temperature when compared with samples without Fe addition.

In samples 6, 7, 14, 15, and 24, the CR product drops to less than 466 MfΩμF. The decrease in CR product in samples 6, 7, 14, 15, and 24 is probably attributable to the fact that the first Fe concentration is 0.4 at % or more in these samples. Therefore, a large quantity of magnetite (Fe₃O₄), which is electrically conductive, was generated in the capacitance region Rc, and this may lead to a drop in insulation resistance between the internal electrodes. Therefore, the first Fe concentration is preferably set at less than 0.4 at %. If the first Fe concentration is set at less than 0.4 at %, the laminated ceramic capacitor can achieve a high CR product.

The characteristics of samples 17 and 18 indicates that the capacitance decreases to less than 9.4 μF if the total of Mn and Mg concentrations in the margin regions Rm is 1.2 at %. The low capacitance in samples 17 and 18 is probably attributable to the excessive amount of Mn and Mg in the dielectric layers. The laminated ceramic capacitors can achieve high capacitance if the total of Mn and Mg concentrations in the margin regions Rm is preferably set less than 1.2 at %.

Judging from the relationship between (i) the first concentration, the (Mn+Mg) concentration and the difference in Fe concentration and (ii) the capacitance, the HALT 50% value and the CR product in samples 1, 3, 5, 9, 11, 13, 19, 21, and 23, the laminated ceramic capacitors can achieve a high HALT 50% value if the first Fe concentration is set at less than 0.4 at %, the total of Mn and Mg concentrations in the margin regions Rm is set at less than 1.2 at %, and the difference in Fe concentration is in the range of 0.4 to 1.15. In one particularly preferable aspect, high insulation reliability can be achieved since the first concentration is less than 0.4 at %, the (Mn+Mg) concentration is less than 1.2 at %, and the difference in Fe concentration is in the range of 0.43 to 1.13 at %.

### 5. Notes

The dimensions, materials, and arrangements of the constituent elements described for the above various embodiments are not limited to those explicitly described for the embodiments, and these constituent elements can be modified to have any dimensions, materials, and arrangements within the scope of the present invention.

Constituent elements not explicitly described herein can also be added to the above-described embodiments, and it is also possible to omit some of the constituent elements described for the embodiments.

The words “first,” “second,” “third” and so on used herein are added to distinguish constituent elements but do not necessarily limit the numbers, orders, or contents of the constituent elements. The numbers added to distinguish the constituent elements should be construed in each context. The same numbers do not necessarily denote the same constituent elements among the contexts. The use of numbers to identify constituent elements does not prevent the constituent elements from performing the functions of the constituent elements identified by other numbers.

The expression of “including” a constituent element used herein does not exclude other constituent elements but rather means that other constituent elements can be further included, as long as they are consistent with the invention.

### (6) Additional Embodiments

Embodiments disclosed herein also include the following.

### Additional Embodiment 1

A laminated ceramic capacitor including:
a body having a first internal electrode layer, a second internal electrode layer, and a dielectric layer disposed between the first internal electrode layer and the second internal electrode layer in a first direction;
a first external electrode provided on the body so as to be electrically connected to the first internal electrode layer; and
a second external electrode provided on the body so as to be electrically connected to the second internal electrode layer,
wherein the body is at least partitioned into:
   a capacitance region where the first internal electrode layer and the second internal electrode layer face each other in the first direction; and
   a margin region where neither the first internal electrode layer nor the second internal electrode layer is present as viewed from the first direction, and
wherein the dielectric layer contains Fe in a first concentration in the capacitance region and contains Fe in a second concentration higher than the first concentration in the margin region.

### Additional Embodiment 2

The laminated ceramic capacitor of [Additional Embodiment 1], wherein a difference between the second concentration and the first concentration is greater than 0.4 at % and less than 1.15.

### Additional Embodiment 3

The laminated ceramic capacitor of [Additional Embodiment 1] or [Additional Embodiment 2], wherein the second concentration is 0.4 at % or greater.

### Additional Embodiment 4

The laminated ceramic capacitor of any one of [Additional Embodiment 1] to [Additional Embodiment 3], wherein the first concentration is less than 0.4 at %.

### Additional Embodiment 5

The laminated ceramic capacitor of any one of [Additional Embodiment 1] to [Additional Embodiment 4],
wherein the margin region contains less than 1.2 at % of a sintering agent, and
wherein the sintering agent is at least one of Mg or Mn.

### Additional Embodiment 6

A circuit module including the laminated ceramic capacitor of any one of [Additional Embodiment 1] to [Additional Embodiment 5].

### Additional Embodiment 7

An electronic device including the circuit module of [Additional Embodiment 6].

### Additional Embodiment 8

A method of manufacturing a laminated ceramic capacitor, the method including:
preparing a plurality of lamination units each having a dielectric green sheet, and an internal electrode pattern and a dielectric pattern formed on the dielectric green sheet, the internal electrode pattern containing a main component metal powder, and the dielectric pattern containing Fe-containing powder and surrounding the internal electrode pattern;
stacking the plurality of lamination units to form a laminate; and
firing the laminate.

### Additional Embodiment 9

The method of [Additional Embodiment 8], wherein, during the firing of the laminate, a temperature of the laminate is raised from a preheating temperature to a firing temperature at a rate of 4000° C./h or higher.

What is claimed is:

1. A laminated ceramic capacitor comprising:
a body having a first internal electrode layer, a second internal electrode layer, and a dielectric layer disposed between the first internal electrode layer and the second internal electrode layer in a first direction;
a first external electrode provided on the body so as to be electrically connected to the first internal electrode layer; and
a second external electrode provided on the body so as to be electrically connected to the second internal electrode layer,
wherein the body is at least partitioned into:
a capacitance region where the first internal electrode layer and the second internal electrode layer face each other in the first direction; and
a margin region where neither the first internal electrode layer nor the second internal electrode layer is present as viewed from the first direction, and
wherein the dielectric layer contains Fe in a first concentration in the capacitance region and contains Fe in a second concentration higher than the first concentration in the margin region.

2. The laminated ceramic capacitor of claim 1, wherein a difference between the second concentration and the first concentration is greater than 0.4 at % and less than 1.15.

3. The laminated ceramic capacitor of claim 1, wherein the second concentration is 0.4 at % or greater.

4. The laminated ceramic capacitor of claim 1, wherein the first concentration is less than 0.4 at %.

5. The laminated ceramic capacitor of claim 1,
wherein the margin region contains less than 1.2 at % of a sintering agent, and
wherein the sintering agent is at least one of Mg or Mn.

6. A circuit module comprising the laminated ceramic capacitor of claim 1.

7. An electronic device comprising the circuit module of claim 6.

8. A method of manufacturing a laminated ceramic capacitor, the method comprising:
preparing a plurality of lamination units each having a dielectric green sheet, and an internal electrode pattern and a dielectric pattern formed on the dielectric green sheet, the internal electrode pattern containing a main component metal powder, and the dielectric pattern containing Fe-containing powder and surrounding the internal electrode pattern;
stacking the plurality of lamination units to form a laminate; and
firing the laminate.

9. The method of claim 8, wherein, during the firing of the laminate, a temperature of the laminate is raised from a preheating temperature to a firing temperature at a rate of 4000° C./h or higher.
